(19) United States
(12) Patent Application Publication
(10) Pub. No.: US 2015/0354618 A1
(43) Pub. Date: Dec. 10, 2015

(54) APPARATUS FOR PREVENTING BOLT RELEASE

(71) Applicants: Hyundai Motor Company, Seoul (KR); Kia Motors Corporation, Seoul (KR); Wooshin Industrial Co., Ltd., Dangjin (KR)

(72) Inventors: Duck Whan Kim, Seoul (KR); Jung Han Yu, Yongin (KR); Yong Woo Choi, Ansan (KR); Tae Min Lee, Seoul (KR); Chang Jun Lee, Hwaseongi (KR)

(21) Appl. No.: 14/527,258

(22) Filed: Oct. 29, 2014

(30) Foreign Application Priority Data
Jun. 10, 2014 (KR) 10-2014-0069890

(51) Int. Cl. F16B 39/28

(52) U.S. Cl. CPC F16B 39/28

(57) ABSTRACT

An apparatus for preventing a bolt release includes: a nut hole formed in a body; and an insulating part formed integrally with a bolt coupled to the nut hole and contacting the body, where a plurality of protruded slopes are formed along a circumference of a bonding surface among a plurality of bonding surfaces between the body and the insulating part according to a relative magnitude of hardness or friction coefficient between the body and the insulating part when the bolt is coupled.

### CROSS REFERENCE TO RELATED APPLICATION

The present application claims under 35 U.S.C. §119(a) the benefit of Korean Patent Application Number 10-2014-0069890 filed on Jun. 10, 2014, which is incorporated by reference herein in its entirety.

### BACKGROUND

(a) Technical Field

The present invention relates to an apparatus for preventing a bolt release, and more particularly, to an apparatus for preventing a bolt release capable of preventing the bolt release by forming an inclined path in a body and providing a washer that moves along the inclined path at the time of occurrence of the bolt release to thereby press a bolt in a shaft direction at the time of is occurrence of the bolt release.

(b) Description of the Related Art

It is important for a fuel cell vehicle to secure electrical insulation between a high voltage and a chassis for electrical safety. However, since a manifold block positioned on a side of a stack to serve as a passage supplying or discharging air, hydrogen, and cooling water to or from a stack module has a very complicated flow path, an aluminum casting method has been used to mass-produce the manifold block. In this case, an electrical path is formed between the stack module (separate plate) and the manifold block by the cooling water for cooling the stack, thereby causing breakdown of electrical insulation of the vehicle. Therefore, a cooling flow path of the manifold block is insulated by a polymer tube so as to be completely blocked from the cooling water.

The protective tube is not a problem in a normal state, but in the case in which it is damaged by external impact or self-deterioration, it may cause degradation in insulation of the vehicle. Therefore, even though the above-mentioned problem possibly occurs in the cooling flow path of the manifold block, it is important to provide an external chassis (vehicle body, stack enclosure, or the like) and the manifold block that are not directly in contact with each other.

To this end, an enclosure bracket a manifold block and the manifold block have a spaced distance secured therebetween or an additional sheath is applied between the enclosure bracket and the manifold block, the electrical insulation is secured by using an insulating washer for a fixed portion, and the manifold block is fixed by using insulated bolts. In addition, all components (hydrogen interface, PRV, ejector, COD-HTR, outlet duct, air duct, and water trap) fixed on the manifold block use the polymeric material having insulating property. Even though a leakage current occurs in the manifold block, a connection with the chassis is disconnected by the processing as described above, such that the insulation may be secured.

Meanwhile, an upper of the manifold block is provided with a fixing part for fixing the manifold block to the enclosure. Since the enclosure is electrically connected to the vehicle body, it has used a fastening method using an intermediate member bolt rather than a direct bolting in order to electrically insulate the manifold block from the chassis. FIG. 1 (RELATED ART) shows a conventional coupled structure of an intermediate member bolt 10 and a manifold block 20 according to the related art, where an insert bolt 12 protruded to be inserted into an insertion groove formed in the manifold block 20 and an insert tap 11 positioned to be opposite to the insert bolt 12 are simultaneously injected, such that the intermediate member bolt 10 secures the insulation. The enclosure 30 is bolt-coupled to the insert tap 11.

However, in the above-described fastening method according to the related art, when the bolt 40 bolting the enclosure 30 onto the insert tap 11 is released, the intermediate member bolt 10 may also be released.

The matters described as the related art have been provided only for assisting in the understanding for the background of the present invention and should not be considered as corresponding to the related art known to those skilled in the art.

### SUMMARY

An object of the present invention is to provide an apparatus for preventing a bolt release capable of preventing a release of an intermediate member by pressing the intermediate member in a shaft direction by providing a washer having an inclined path formed to be protruded between the intermediate member and a manifold block and forming an engaging part contacting the inclined path of the washer in the manifold block or the intermediate member.

According to an exemplary embodiment of the present invention, there is provided an apparatus for preventing a bolt release, the apparatus including: a nut hole formed in a body; and an insulating part formed integrally with a bolt coupled to the nut hole and contacting the body, wherein a plurality of protruded slopes are formed along a circumference in at least one of a plurality of bonding surfaces between the body and the insulating part according to relative magnitude of hardness or friction coefficient between the body and the insulating part when the bolt is coupled.

The apparatus may further include a tightening washer arranged between the insulating part and the body, wherein the tightening washer has one surface having a plurality of protruded inclined paths engaged with the slopes formed thereon and another surface having a serration formed thereon to thereby be frictionally in contact with a bonding surface on which the slopes are not formed among the bonding surfaces between the body and the insulating part.

The slope or the inclined path positioned at the body side may be formed to have a height which is gradually increased toward a release direction of the bolt to thereby press the insulating part in a shaft direction when the bolt is released.

The slope may be formed on a bonding surface of the body side, and the body may have a friction coefficient smaller than that of the insulating part and have a hardness greater than that of the insulating part.

The slope may be formed on a bonding surface of the insulating part side, and the insulating part may have a friction coefficient smaller than that of the body and have a hardness greater than that of the body.

The body may be a manifold block of a fuel cell for vehicle, and the insulating part may to be coupled to a vehicle body to thereby insulate between the manifold block and the vehicle body.

The insulating part may be provided with an insertion hole having a screw thread formed along an inner peripheral surface thereof and the vehicle body may be bolt-coupled to the insertion hole.

The slope may be formed to be engaged with both a bonding surface of the body side and a bonding surface of the insulating part side.

### BRIEF DESCRIPTION OF THE DRAWINGS

FIG. 1 (RELATED ART) is a view in which an intermediate member bolt according to the related art is installed;

FIGS. 2A and 2B are configuration diagrams of an apparatus for preventing a bolt release according to a first exemplary embodiment of the present invention;

FIGS. 3A and 3B are configuration diagrams of an apparatus for preventing a bolt release according to a second exemplary embodiment of the present invention;

FIGS. 4A and 4B are views showing tightening washers according to the first and second exemplary embodiments of the present invention; and

FIGS. 5A to SC are configuration diagrams of an apparatus for preventing a bolt release according to a third exemplary embodiment of the present invention.

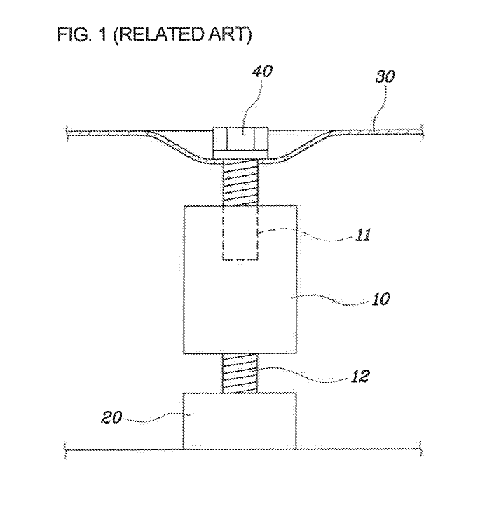

### DESCRIPTION OF THE EXEMPLARY EMBODIMENTS

Hereinafter, an apparatus for preventing a bolt release according to exemplary embodiments of the present invention will be described with reference to the accompanying drawings.

It is understood that the term “vehicle” or “vehicular” or other similar term as used herein is inclusive of motor vehicles in general such as passenger automobiles including spots utility vehicles (SLY), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

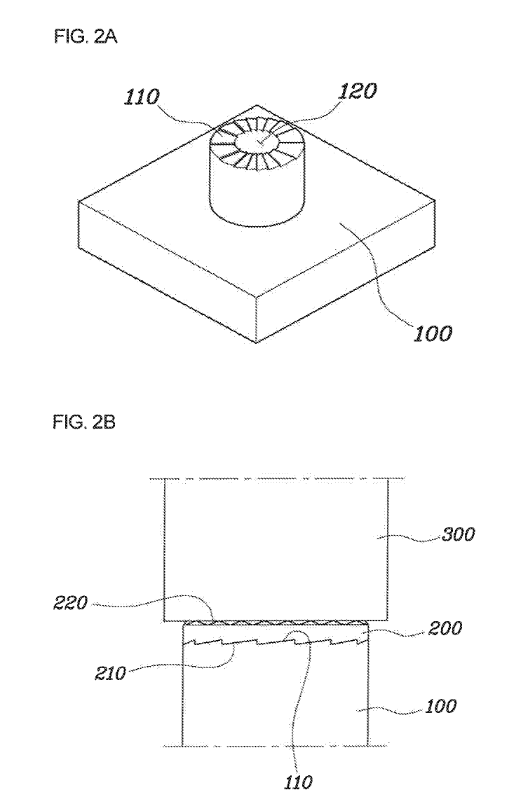

FIGS. 2A, 2B, 3A, 3B, 5A, 5B, and 5C are configuration views of an apparatus for preventing a bolt release according to first to third exemplary embodiments of the present invention. The apparatus for preventing the bolt release according to the first to third exemplary embodiments includes a nut hole 120 formed in a body; and an insulating part 300 formed integrally with a bolt 320 coupled to the nut hole 120 and contacting the body 100, where a plurality of protruded slopes 110 and 310 are formed along a circumference in a bonding surface (i.e., at least one bonding surface) among a plurality of bonding surfaces between the body 100 and the insulating part 300 according to a relative magnitude of hardness or friction coefficient between the body 100 and the insulating part 300 when the bolt 320 is coupled.

Preferably, the body 100 may be a manifold block of a fuel cell for a vehicle, the insulating part 300 may be configured to be coupled to a vehicle body to insulate between the manifold block and the vehicle body, the insulating part 300 may be provided with an insertion hole having a screw thread formed along an inner peripheral surface, and the vehicle body may be bolt-coupled to the insertion hole. In particular, one end of the insulating part 300 is integrally coupled to the bolt 320 and the other end of the insulating part 300 is provided with the insertion hole, such that the manifold block and the vehicle are coupled to each other. The vehicle body may include an enclosure surrounding the fuel cell, and the insulating part 300 may have the same configuration as the related art.

The apparatus for preventing the bolt release according to the first to third exemplary embodiments of the present invention is not limited to be used only in conjunction with a fuel cell, but may be used throughout the vehicle.

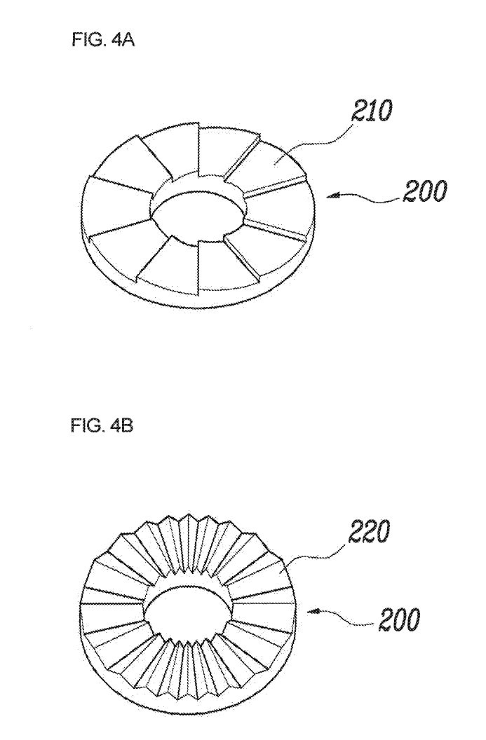

Meanwhile, according to first and second exemplary embodiments of the present invention, a tightening washer 200 may be further included between the insulating part 300 and in the body 100, where the tightening washer 200 has one surface having a plurality of protruded inclined paths 210 engaged with the slopes 110 and 310 formed thereon and the other surface having a serration 220 formed thereon to thereby be frictionally in contact with a bonding surface on which the slopes 110 and 310 are not formed among the bonding surfaces between the body 100 and the insulating part 300. FIGS. 4A and 4B are views showing tightening washers 200 according to the first and second exemplary embodiments of the present invention, where FIG. 4A shows one surface and FIG. 4B shows the other surface.

The tightening washer 200 is frictionally in contact with the bonding surface of the body 100 or the insulating part 300 by the serration 220 formed on the other surface thereof when the bolt 320 and the body 100 are tightened to thereby be moved together with the body 100 or the insulating part 300, and presses the insulating part 300 in a shall direction for the body 100 by the inclined path 210 formed on one surface thereof when the bolt 320 is released by the vibration of the vehicle or external force to thereby prevent the insulating part 300 from being rotated in a release direction.

In particular, the slope 110 or the inclined path 210 positioned at the body 100 side is formed to have a height which is gradually increased toward a release rotation direction of the bolt 320, such that the insulating part 300 is pressed in the shaft direction when the bolt 320 is released.

For example, when the bolt 320 is released in a counterclockwise direction from the out hole 120, a gradient of the slope 110 or the inclined path 210 positioned at the body 100 side is formed so that a height protruded toward the insulating part 300 is increased toward the counterclockwise direction, such that the insulating part 300 is pressed in a separation direction of the bolt 320, that is, in a direction opposite to the body 100 side direction, thereby preventing the insulating part 300 from being additionally released by resistance between the slope 110 and the inclined path 210.

Meanwhile, FIGS. 2A and 2B are configuration diagrams of an apparatus for preventing a bolt release according to a first exemplary embodiment of the present invention, where FIG. 2A shows the slope 110 on the body 100, and FIG. 2B shows a state in which the insulating part 300 and the body 100 are assembled. According to the first exemplary embodiment of the present invention, the slope 110 is formed on the bonding surface of the body 100 side, where the body 100 has a friction coefficient smaller than that of the insulating part 300 and has a hardness greater than that of the insulating part 300.

The above-mentioned friction coefficient and hardness are preferably the friction coefficient and hardness on the bonding surface. Because there is a possibility that a slip occurs between the bonding surface and the other surface of the tightening washer 200 as the friction coefficient becomes low and the hardness becomes high, the slope 110 is formed integrally on a bonding surface having a relatively low friction coefficient and a relatively high hardness among the bonding surface of the body 100 side and the bonding surface of the insulating part 300 side, such that the slope 110 may be provided without worrying about a slip occurrence even in a state in which the tightening washer 200 is not additionally provided. The slope 110 is preferably molded together with a molding of the body 100 to be formed integrally with the body 100, but is not limited thereto. For example, after being separately molded, the slope 110 may be integrally formed by various coupling means such as bonding, bolting, or the like. In addition, the slope 110 preferably is formed in a ring shape along a circumference of the nut hole 120 and may be formed to have a protruded height which is gradually increased toward the release direction of the bolt 320.

As the slope 110 is formed on the bonding surface of the body 100 side, the tightening washer 200 maintains a state in which it is engaged with the inclined path 210 formed on one surface thereof in a state in which the insulating part 300 is tightened, and is rotated together with the insulating part 300 when the insulating part 300 is rotated in the release direction by the vibration or external force. Thereby, the inclined path 210 is moved along the slope 110 and presses the insulating part 300 in a shaft moving direction at the time of the release of the insulating part 300, thereby making it possible to prevent a release rotation of the insulating part 300.

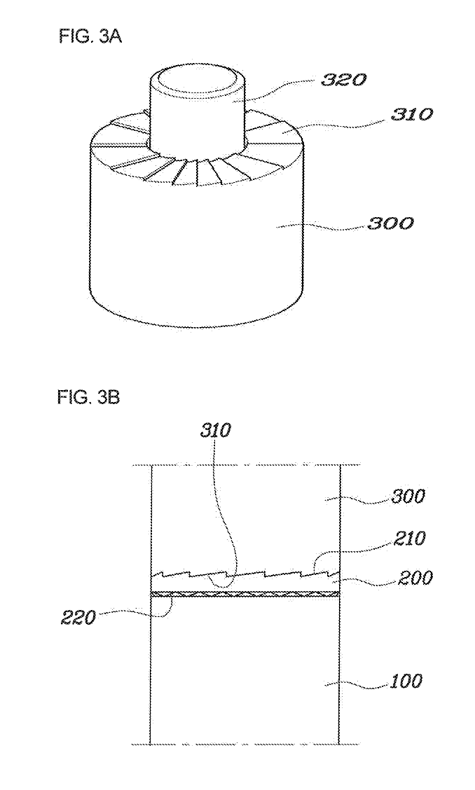

Meanwhile, FIGS. 3A and 3B are configuration diagrams of an apparatus for preventing a bolt release according to a second exemplary embodiment of the present invention, where FIG. 3A shows the slope 310 on the insulating part 300 and FIG. 3B shows a state in which the insulating part 300 and the body 100 are assembled. The slope 310 is formed on the bonding surface of the insulating part 300 side, where the insulating part 300 has a friction coefficient smaller than that of the body 100 and has a hardness greater than that of the body 100.

The second exemplary embodiment is similar to the first exemplary embodiment, but a position in which the slope 310 is formed and a position in which the other surface of the tightening washer 200 is frictionally in contact with are reversed. In this case, the slope 310 is configured to have a height which is gradually decreased toward the release direction of the bolt 320, that is, have a height which is gradually increased toward a tighten direction of the bolt 320, and the inclined path 210 engaged with the slope 310 is preferably configured to have a height which is gradually increased toward the release direction of the bolt 320.

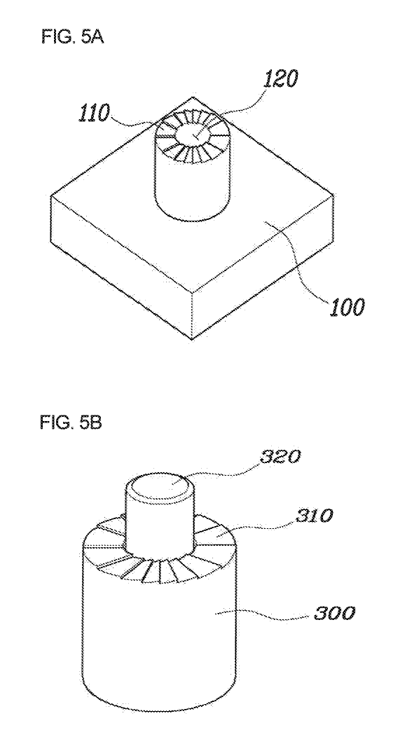

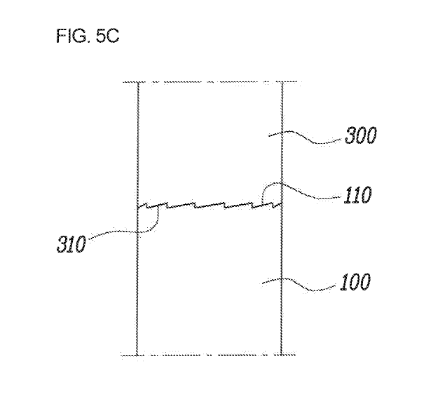

Meanwhile, FIGS. 5A to 5C are configuration diagrams of an apparatus for preventing a bolt release according to a third exemplary embodiment of the present invention, where FIG. 5A shows the slope 110 on the body 100, FIG. 5B shows the slope 310 on the insulating part 300 side, and FIG. 5C shows a state in which the insulating part 300 and the body 100 are assembled. The slopes 110 and 310 may be formed to be engaged with both the bonding surface of the body 100 side and the bonding surface of the insulating pan 300 side. In particular, the slopes 110 and 310 are formed integrally with both the body 100 and the insulating part 300 without having the tightening washer 200.

Even in the case in which the tightening washer 200 is not separately provided, the insulating part 300 is pressed when the bolt 320 is rotated in the release direction to thereby prevent the rotation, thereby making it possible to prevent the release of the bolt 320. In addition, costs occurred due to provision of the tightening washer 200 may be reduced, and the slip which may occur between the other surface of the tightening washer 200 and the bonding surface may be basically prevented, thereby making it possible to efficiently generate an effect of preventing the bolt 320 release by the contact between the slopes 110 and 310.

According to the apparatus for preventing the bolt release having the structure as described above, since the bolt release is prevented by the tightening washer having the inclined path formed therein and the bolt does not need to be tightened alter the enclosure is separated, the number of work processes may be reduced.

In addition, even in the case in which the bolt is partially rotated in the release direction by the vibration of the vehicle, the bolt may continuously maintain a state in which it is tightened on the manifold block, thereby making it possible to facilitate insulation and coupling stability.

In addition, even in the case in which a difference in the hardness of the manifold block and the bolt head occurs, the inclined path is formed in one having the greater hardness among the manifold block and the bolt head, such that a release occurrence due to a slip may be prevented as compared to a case in which a plurality of tightening washers are provided.

Although the present invention is shown and described in connection with the specific embodiments, it is apparent to those skilled in the art that the modifications and variations can be made without departing from the spirit and scope of the invention as defined by the appended claims.

What is claimed is:

1. An apparatus for preventing a bolt release, the apparatus comprising:
a nut hole formed in a body; and
an insulating part formed integrally with a bolt coupled to the nut hole and contacting the body,
wherein a plurality of protruded slopes are formed along a circumference in at least one of a plurality of bonding surfaces between the body and the insulating part according to a relative magnitude of hardness or friction coefficient between the body and the insulating part when the bolt is coupled.

2. The apparatus of claim 1, further comprising a tightening washer arranged between the insulating part and the body, wherein the tightening washer has one surface having a plurality of protruded inclined paths engaged with the slopes formed thereon and another surface having a serration formed thereon to thereby be frictionally in contact with a bonding surface on which the slopes are not formed among the bonding surfaces between the body and the insulating part.

3. The apparatus of claim 2, wherein the slope or the inclined path positioned at the body side is formed to have a height which is gradually increased toward a release direction of the bolt to thereby press the insulating part in a shaft direction when the bolt is released.

4. The apparatus of claim 1, wherein the slope is formed on a bonding surface of the body side, and the body has a friction coefficient smaller than that of the insulating part and has a hardness greater than that of the insulating part.

5. The apparatus of claim 1, wherein the slope is formed on a bonding surface of the insulating part side, and the insulating part has a friction coefficient smaller than that of the body and has a hardness greater than that of the body.

6. The apparatus of claim 1, wherein the body is a manifold block of a fuel cell for vehicle, and the insulating part is coupled to a vehicle body to thereby insulate between the manifold block and the vehicle body.

7. The apparatus of claim 6, wherein the insulating part is provided with an insertion hole having a screw thread formed along an inner peripheral surface thereof, and the vehicle body is bolt-coupled to the insertion hole.

8. The apparatus of claim 1, wherein the slope is formed to be engaged with both a bonding surface of the body side and a bonding surface of the insulating part side.
